(19) United States
(12) Patent Application Publication
(10) Pub. No.: US 2004/0039085 A1
(43) Pub. Date: Feb. 26, 2004

(54) Acid-methylol compound reaction products for flame resistance

(76) Inventors: Robert Valentine Kasowshi, West Chester, PA (US); Maya Melter Kasowshi, West Chester, PA (US)

Correspondence Address: Robert V Kasowshi, 2153 Brinton Bridge Road, West Chester, PA, 19382, US

(21) Appl. No.: 10/275,239

(22) PCT Filed: Mar. 27, 2001
(86) PCT No.: PCT/US01/09514

(51) Int. Cl. C09K 21/00; C08K 3/04; C08K 9/00; C08K 3/40

(52) U.S. Cl. 523/216; 252/606; 524/494; 524/495

(57) ABSTRACT

This invention relates to novel flame retardants (FR) resulting from the reaction of (a) or (b) with (c) where (a) is a compound containing at least one amine group and with at least one sixteenth of the amine molecules having at least one methylol bond, (b) is a phenol with at least one sixteenth of the phenol molecules having at least one methylol bond, and (c) is a mineral acid, organic acid, and organo-phosphorous acid, or a mixture thereof and optionally adding a polyhydric compound and/or optionally adding formaldehyde to the acid. These compositions are for use in general flame retardant applications such as coatings, adhesives, and articles made of polymeric materials. The FR mechanism by which these compounds generally perform as an FR agent is intumescence but the field of this invention is not restricted to that mechanism. Some of the compounds have substantial intumescence and others have very little intumescence but still are flame retardants.

### FIELD OF INVENTION

This invention relates to novel flame retardants and compositions containing these flame retardants (FR) as well as a novel process for the preparation of the flame retardants.

### BACKGROUND OF INVENTION

Flame retardants that work via the mechanism of intumescence usually do not contain halogens. The flame-retardant mechanism of intumescence has been reviewed. (For a review of intumescence in coatings and polymers: Don G. Brady, C. Wayne Moberly, John R. Norell, and Harold C. Walters, J. Fire Retardant Chemistry, 4, p150(1977)). The intumescent FR mechanism requires an inorganic acid source, a carbon source such as a polyhydric material like dipentaerythritol, and a blowing agent which is often an amine like urea or melamine. Optionally, a halogen containing compound can be added for better activity. For coatings, the FR agent includes the following types of compounds: a mineral acid salt such as sodium phosphate or ammonia polyphosphate, a polyol such as starch, pentaerythritol, or dipentaerythritol, and a blowing agent such as melamine. The standard theory is that in a fire, the heat causes the mineral acid salt to decompose to form an acid, the acid dehydrates the polyol to form char, and the blowing agent decomposes to gaseous products. The result is char and gas that forms a foam that is much thicker than the original article or coating containing these FR agents. A sequence of events with respect to formation of acid, dehydration of polyol, and release of gas must occur in the correct order and time sequence for the gas and char to form a protective foam. Different polymers may require different ingredients or amounts of ingredients to achieve similar levels of flame retardation. It is believed that the polymer and the FR agent must have similar decomposition temperatures. Thus, different mineral acid salts, polyols, or blowing agents are used in different applications and there is no universal recipe.

Therefore, a need exists for a single compound that performed all the tasks of the mineral acid salt, the polyol, and the blowing agent and be generally applicable to wide variety of polymers. Intumescence can be difficult to achieve in practice. It is often difficult for three or more ingredients to be well mixed in applications such as flame retarding a polymer. Good mixing of three ingredients in coating applications can be difficult if the ratio of solids content to solvent is very high. It is much more difficult to flame retard a polymer with three ingredients, because the above intumescence agents are added to the polymer melt. Relatively high viscosity of the polymer melt prevents easy mixing of FR agents to obtain a homogeneous mix and good performance. Mixing a melted polymer for a long time to obtain a good dispersion of the FR agents is unacceptable as the polymer can degrade if held above melt temperature too long. The flame resistance of polyolefms such as polypropylene can be improved by adding melamine pyrophosphate (MMP) and dipentaerythritol. (as taught in U.S. Pat. No. 3,936,416, 1976). This patent teaches that multiple components need be mixed into the polypropylene for good FR performance via intumescence, as melamine pyrophosphate by itself requires too high a loading. FR performance will be dependent on uniformity of mixing of the components melamine pyrophosphate and dipentaerythritol into polypropylene. A single compound FR agent would be easier from a mixing standpoint as maintaining the FR agents in close proximity and balance throughout would not be as crucial. For plastics in general, it is difficult to disperse the ingredients as each ingredient may disperse differently or even agglomerate in the polymer melt.

### SUMMARY OF INVENTION

This invention provides FR compounds that provide flame retardation for a variety of applications so as to replace the use of FR agents containing halogens. The flame retardant used in many applications contain brominated or chlorinated compounds. There is a ready market for FR agents that do not contain halogens which this invention addresses.

The invention is a composition that comprises the reaction product of either (a) or (b) with (c):

(a) one to four moles of an amine wherein at least one sixteenth of the amine molecules have at least one methylol bond and the maximum being fully methylolated amine molecules;

(b) one to four moles of a phenol wherein at least one sixteenth of the phenol molecules have at least one methylol bond and the maximum being fully methylolated phenol molecules; and

(c) one mole of a compound selected from the group consisting of a mineral acid, an organic acid, an organo-phosphorous acid, and a mixture of the acids and optionally containing zero to one mole of polyhydric material and optionally containing zero to one mole of formaldehyde

A process for preparing the composition of claim I comprises the slow addition of a solution or mixture of (a) or (b), which is at a temperature less than or equal its boiling point, to a solution or mixture of (c), which is at a temperature less than or equal its boiling point, with the solvent for these solutions being water, an organic solvent, or a mixture of one or more thereof and with the further steps of heating the solutions to a temperature less than or equal the boiling point during and after mixing, drying the resultant reaction product, and then heating at a temperature greater than about 90° C. but less than about 340° C. for less than 60 minutes

These reaction products incorporate into one compound all the ingredients for intumescence. The intumescence is very strong for certain compounds in this series formed between strong acids such as pyrophosphoric acid and methylolated melamine and weak for other compounds of this invention formed between a weak acid such as boric acid or cyanuric acid and methylolated melamine.

The compounds of this invention may require coating with about 0.1% to 1% by weight of organo functional silanes or other known compatibilizers to facilitate uniform distribution within the material or materials being flame retarded. The compounds of this invention additionally may require coating with a base to suppress acidity. Suitable bases can be organic such as ethylene diamine or common bases such as sodium hydroxide, ammonium hydroxide, or calcium hydroxide.

The compounds of this invention may also be ground to average particle less than 3 microns. It is well known that small particles can give better FR properties and better mechanical properties than large particles. Small particles are often necessary for applications involving films and fibers.

The compounds of this invention can be used to form polymer compositions comprising

(d) 1 to 60 per cent by weight of a compound from the reaction product of (a), (b), (c) discussed above and

(e) 99 to 40 per cent by weight of a polymer material which is either a thermoplastic with a melting point or substantial softening point greater than 80° C., a thermoset, or a latex coating composition.

The composition can be in any form such as fiber, film, coating, or solid object.

Other ingredients may be added to these compositions: For example, pigments are added for color and mica, chopped glass, carbon fibers, or aramids are added to alter the mechanical properties. Other flame retardants even halogen containing can be added.

### DETAILED DESCRIPTION OF INVENTION

The composition described herein is the reaction product of a methylolated amine or methylolated phenol component with an acid and optionally a polyhydric ingredient in specific ratios.

Amines as used herein are derivatives of ammonia with one or two hydrogen atoms and the remaining groups being alkyl, aryl, or other groups bonded to the nitrogen atom. Amines include primary and secondary as well as mixtures thereof. Amides are also included in this general definition. Thus, urea and melamine and their mixtures are considered together under the term amines even though urea is a diamide and melamine is a triamino triazine. [see Organic Chemistry, 2^{nd} edition, by L. G. Wade, Jr., Prentice Hall, Englewood Cliffs, N.J., 1991.]

For the purpose of this invention, amine compounds are defined here as monomeric nitrogen compounds that contain at least one trivalent nitrogen atom such as —NH₂ or —NRH where R is an akyl, aryl, or other group, leaving one or two N—H bonds. This definition also includes amides of the form —CONH₂ or —CONRH. This definition encompasses diverse compounds and their mixtures such as melamine, substituted melamine, ethylene diamine, urea, and substituted urea as well as many other amines such as methylene bis-amines.

This invention also includes phenol compounds and their mixtures which are easier to define as aromatic organics with a hydroxyl group attached to the aromatic group. Phenol compounds are selected from the group consisting of phenol, alkylated phenols, aryl phenols, methylenebis-phenols, and mixtures of these compounds

The present invention comprises a new process for formation of compositions from the reaction product of an acid with methylolated amine compounds or methylolated phenol compounds. The first step of methylolation can be done in water, organic solvent, or another suitable solvent.

Methylolation of N—H bond:

R—NH₂+HCHO [symbol] R—NH—CH₂OH

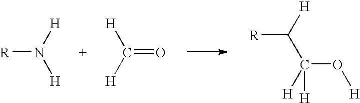

Such compounds are referred to as methylol amines. For phenols, any of the C—H bonds add a formaldehyde to form a methylol bond.

The molar formaldehyde to amine or phenol ratio can be adjusted from about one sixteenth to having excess formaldehyde to methylolate all the amine and phenol functionalites that can be methylolated. There can be two methylol bonds per —NH₂ and one methylol per —NRH. Methylolation will in most cases occur without a base catalyst if the formaldehyde and amine compound are heated near boiling usually within an hour depending on the concentration of formaldehyde in the solvent. An acid catalyst is specifically not introduced so that condensation with formation of methylene bridges is avoided in this first stage. The inherent acidity of formaldehyde due to formic acid will cause some dimers and trimers to form which are incorporated as part of our reaction product. It is preferred but not essential to add enough formaldehyde and solvent to form a clear solution of methylolated amine or phenol. Addition of base can greatly aid methylolation but has been avoided so as not to contaminate the final product. The next step is to slowly add the methylol amine or methylol phenol solution to the acid solution. Usually, the molar formaldehyde to amine or phenol ratio is kept at about 1 to minimize the use of formaldehyde. The temperature of the solutions is kept near boiling so that methylol bonds form rapidly. The concentrations range from about 1% to 60%. If the amount of formaldehyde is chosen so that only a small portion of the amine molecules are methylolated, then a mixture may result as not all the molecules will dissolve in the solvent/formaldehyde. Amines of low solubility such as melamine form mixtures, not solutions if the formaldehyde content is low. Such mixtures react more slowly but still are included in the process and not distinguished from clear solutions. The amount of solvent, if any, used in forming the reaction product also is an important factor in whether a solution or mixture is formed.

The acid can be any of the strong mineral acids such as phosphoric acid, pyrophosphoric acid, polyphosphoric acid, phosphonic acid, phosphinic acid, phytic acid, sulfuric acid, and pyrosulfuric acid and other strong mineral acids that form compounds with good thermal stability. Strong organic acids such as the organic sulfonic acids are suitable. Suitable benzenesulfonic acid type compounds include benzenesulfonic acid, p-aminobenzenesulfonic acid, m-aminobenzenesulfonic acid, o-aminobenzenesulfonic acid, p-sulfobenzoic acid, m-sulfobenzoic acid, o-sulfobenzoic acid, p-phenolsulfonic acid, m-phenolsulfonic acid, o-phenolsulfonic acid, 2,4-phenoldisulfonic acid, 1,3,5-benzenetrisulfonic acid, p-benzenedisulfonic acid, m-benzenedisulfonic acid, p-nitrobenzenesulfonic acid, p toluene sulfonic acid, and m-nitrobenzenesulfonic acid. More acids include tetralcis hydroxymethyl phosphonium chloride and tetrakis hydroxymethyl phosphonium sulfate. The desired new FR agent of this invention can also be formed with mixtures of mineral acids and organic acids. Boric acid and cyanuric acid are rather weak acids but suitable even though the amount of intumescence will be smaller than with strong acids. The low solubility of cyanuric acid in water does not prevent its use to form methylolated melamine cyanurate.

Certain acids are difficult to obtain in very pure form. Pyrophosphoric acid will be contaminated with orthophosphoric acid as there is an equilibrium between the two acids with ortho being the more stable. p-Toluene sulfonic acid may be contaminated with sulfuric acid. Thus, it is preferable to employ acids that have been freshly prepared from alkali metal salts with use of ion exchange resins. For example, pyrophosphoric acid, toluene sulfonic acid, phytic acid, and boric acid can be prepared from the appropriate pure sodium salts using the acidic ion exchange resin, Amberlite 120H from Rohm and Haas, Philadelphia, Pa. An aqueous solution of the appropriate salt is mixed with Amberlite® 120H for a few minutes, at which time almost all the sodium ions are removed leaving the pure acid. The acidity of the prepared acid will depend on whether all the sodium ions are removed. An acidity below pH equal 3 is adequate for strong acids, thus not all the sodium must be removed to prepare the compounds of this invention. The most preferred for strong acids is pH less than 1.4. For weak acids such as boric acid it is preferable to remove most of the sodium ions from the sodium borate salt parent compound. Addition of ion exchange resin via a batch process does not remove all the sodium ions unless repeated a few time. It is preferred to use an ion exchange column to remove nearly all the sodium ions. The batch process is very convenient in a laboratory setting making compounds on a small scale.

In principle any amine compound that can form methylol bonds is suitable to be reacted with the various acids. Examples of suitable compounds are urea, substituted akyl ureas, thiourea, akyl thiourea, cyanamide, ethylenediurea, aniline, dicyandiamide, guanidine, guanamine, benzoguanamine, acetoguanamine, glycoluril, acrylamide, methacrylamide, melamine, benzene sulfonamide, naphthalene sulfonamide, toluene sulfonamide, ammeline, ammelide, guanazole, phenylguanazole, carbamoylguanazole, dihydroxyethyleneurea, ethyleneurea, ethylene diamine, propylene urea, melem (C₆H₆N₁₀), melam (C₆H₉N₁₁), octadecylamide, glycine, and their mixtures. Sulfonamides and phosphoramides are also suitable. Suitable phenol compounds are phenol and aryl or alkyl-substituted phenols including cresol, xylenol, p-tert-butyl-phenol, p-phenylphenol, resorcinol, biphenol, catechol, hydroquine, bisphenol-A, and their mixtures. The preferred amine is melamine and phenol is preferred.

It is further desirable sometimes to mix amines to obtain advantage such as altering the acidity of the reaction product with the acid. It is further desirable sometimes to mix phenols to obtain advantage for similar reason.

Low molecular weight amino and phenol resins containing mostly monomers with some dimers and trimers joined by methylene bridges are commercially available. These resins often have been already reacted with methanol so that the functional groups are methylated (—NHCH₂OCH₃) and have better solubility. Commercially available resins containing methylolated molecules can be reacted by slow addition to the acid solution to form the compounds of this invention. The dimers are here referred to as methylenebis-amines and methylenebis-phenols. For example, low molecular weight amino resins dissolved in a solvent, low molecular weight phenolic resins dissolved in a solvent, and low molecular weight aniline resins dissolved in a solvent can be slowly added to an acid solution to form the compounds of the invention. Specific dimers that serve as examples are methylenebisurea, methylenebisethylurea, methylenebisthiourea, methylenebisethyleneurea, methylenebismelamine, methylenebispentamethylmelamine, and methylenebisacrylamide. Methylol compounds can be used such as dimethyloldihydroxyethyleneurea (DMDHEU) and bismethoxymethyluron both of which are available commercially.

The degree of or the number of methylol bonds per amine molecule can be varied and optimized for best performance which is often a balance between FR behavior and mechanical properties. It is preferred to have at least one methylol group per amine compound. The maximum is one methylol bond per nitrogen-hydrogen bond. For melamine, the number of methylol bonds can vary from one per melamine to six per melamine molecule. For urea, the number of methylol bonds can vary from one to four per urea molecule, with four being very difficult to make. It is preferred to have approximately one methylol bond per amine molecule to have the desired reactivity with the acid. It is not necessary for all the amine molecules to have methylol bonds, but it is preferred for most to be methylolated.

The ratio of methylolated amine compound to acid can be varied substantially depending on the acid. For example, phosphoric acid has 3 sites, pyrophosphoric acid has four sites, polyphosphoric acid has one acid site per phosphorous atom, sulfuric acid has two sites, and toluene sulfonic acid has one acid site. The methylol amine molecules and the acid react to form a compound. A practical approach is to react one to four moles of methylol amine or methylol phenol with one mole of acid.

The preferred flame retardant for polymers that inherently form some char is the reaction product of methylol melamine with phosphoric acid, pyrophosphoric acid, or polyphosphoric acid. This example also demonstrates the complex compositional range of compounds that are possible. There are four possible acid sites for pyrophosphoric acid and one per phosphorous atom for polyphosphoric acid. It is possible to have from one to six methylol bonds per melamine molecule as there are three amine bonds per melamine. The best practice depends on the particular application requiring flame retardance. The preferred choice is a ratio of two to three moles of methylol melamine per mole of pyrophosphate and one to three methylol bonds per melamine. The most preferred is about two moles of methylol melamine with one methylol per melamine with one mole of pyrophosphoric acid. A similar preferred choice should be made for methylol melamine and polyphosphoric acid reaction product: two to three moles of methylol melamine per two moles of polyphosphoric acid. The most preferred is two moles of methylol melamine with one methylol per melamine with two moles of polyphosphoric acid. This choice gives good intumescence and char formation when added to polymers. Melamine is preferred for better hydrolytic and thermal stability and less solubility in water as compared to urea. The reaction product with methylol urea could be a better choice in other situations. Sometimes, reaction products of the acids with the more expensive methylolated benzoguanamine; methylolated ethylenediurea, or methylolated glycouril could be more preferred in a particular application. The most preferred could be the salt of phosphoric acid because of lower cost.

The preferred process consists of slowly adding a previously prepared methylol melamine solution to a solution of phosphoric acid, pyrophosphoric acid, or polyphosphoric acid. The methylol melamine solution is preferred to be within the temperature range of about 60° C. to 100° C. which is added to the acid solution which is being heated. The reaction product is brought to a temperature less than 100° C. Dry the reaction product and then heat treat at a temperature less than 360° C. for less than 60 minutes. A less preferred preparation is to add the formaldehyde to the acid solution, then add the unmethylolated amine to the acid/formaldehyde solution. Methylol melamine is not separately made, a process simplification. In both cases, vacuum distillation results in nearly 100% yield, as the product does not require washing.

The intumescent behavior can be substantially enhanced by addition of a polyhydric compound. That the polyhydric can be added at a near molecular level is unexpected and dependent on compatibility of polyhydric solutions with acid solutions. It was unexpected that the reaction product of one mole of pentaerythritol dissolved in water with one mole of pyrophosphoric acid forms a thick, very viscous liquid after removal of the water. There is no white powder indicative of pentaerythritol precipitation as a separate phase. This compound intumesces when heated in an oven which was unexpected as it contained no blowing agent. It was further surprising that a solution of methylol melamine can be added to an aqueous solution of pentaerythritol and pyrophosphoric acid to form a reaction product that has intumescent properties greater than that of the reaction product of methylol melamine and pyrophosphoric acid.

The preferred composition with polyhydric component contains the following ratio: (1) two to three moles of methylol melamine, with one to three methylol bonds per melamine, and (2) one mole of pyrophosphoric acid or two moles of polyphosphoric acid or two moles of phosphoric acid with approximately 0.1 moles to 1.0 mole of pentaerythritol. The most preferred is two moles of methylol melamine with one methylol per melamine per one mole of pyrophosphoric acid or two moles of polyphosphoric acid and 0.1 to 0.5 moles of pentaerythritol. Preferred synthesis consists of addition of aqueous solution of methylol melamine to aqueous solution of acid/pentaerythritol at a temperature less than 100° C. for both solutions. Heat treatment conditions after drying is dependent on the particular application. This reaction product containing a polyhydric compound inherently forms a lot of char and would be most preferred for flame retarding polyolefins such as polyethylene, polypropylene, polystyrene and their co-polymers which form little or no char when burned. The generalized composition is the reaction product of a methylolated amine or phenol with a polyhydric compound and an acid.

It is sometimes useful to partially replace 5% to 50% of the hydrogens of the methylol bond (—CH₂OH) with an alkyl group such as methyl (—CH₂OCH₃) to increase the solubility and stability of the methylolated compound and retard premature condensation. This reaction of the methylol bond with alcohols is often done in access alcohol so as to suppress condensation via methylene formation. The reaction product of this invention could be formed by slow addition of the alkylated methylol amine solution to a solution or mixture of acid with or without polyhydric.

This invention is also applicable to complex acids that result from the reaction of organic compounds with phosphorous compounds. Such compounds will be referred to as organo-phosphorous acids. A variety of such organo-phosphorous acid flame retardants have been produced by reacting phosphorous oxy-chloride (POCl₃) and pentaerythritol at various molar ratios to form various compounds such as pentaerythritol phosphate and pentaerythritol diphosphate. Organo-phosphorous acids such as these pentaerythritol phosphates can be further reacted with amines such as melamine. More specifically, these organo-phosphorous acids can be reacted with methylol amine and phenol compounds to form the compounds of this invention, and organic solvents will be typically used. For example, our reaction products can be formed by reacting methylol amines or methylol phenols with bicyclic organic derivatives (a generalized pentaerythritol phosphite or pentaerythritol phosphate) of phosphorous having the formula

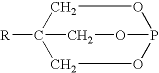

or the formula

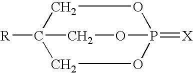

where R is hydroxylmethyl or alkyl and x is oxygen or sulfur.

Typical examples (from U.S. Pat. No. 3,293,327) of bicyclic phosphorous compounds are pentaerythritol phosphite, pentaerythritol phosphate (2,6,7,trioxa-1-phosphabicyclo[2.2.2]octane-4-methanol-1-oxide), trimethylolpropane phosphite, trimethylolpropane phosphate, or pentaerythritol thiophosphate.

The reaction product of methylol amine and bicyclic organic phosphorous is

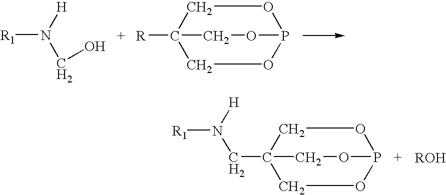

A similar reaction holds for the bi-cyclic phosphate.

Another example of an organo-phosphorous acid is bis-monocyclic acid phosphate of pentaerythritol, defined as pentaerythritol di-phosphate (3,9-dihydroxy-2,4,8,10-tetraoxa-3,9-diphosphaspiro [5,5]-undecane 3,9-dioxide),

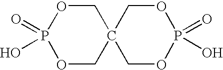

which can also be reacted with the methylol amines and methylol phenols to make the reaction products of this invention.

Another suitable organo-phosphorous acid di-pentaerythritol tri-phosphate to be reacted with methylol amines and methylol phenols is bis(2,6,7-trioxa-1-phoshabicyclo[2,2,2]-octane-4-methanol) phosphate

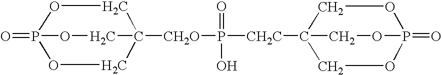

A widely used flame retardant is tri-phenyl phosphate (TPP) made by reacting phenol and phosphorous oxy-chloride. This compound does not self-intumesce. A self-intumescing verion of TPP is the reaction product of methylol phenol with phosphorous oxychloride or methylol amine with phosphorous oxy-chloride. Phosphorous oxy-chloride is included as an example of an acid chloride. A person knowledgeable in this chemistry could make the appropriate modifications to make the compounds of this invention.

We next describe the example of the complex organo-phosphorous acid with the composition poly (hydrocarbylene aryl phosphate) that has been methylolated and

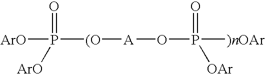

where Ar is either a unsubstituted or substituted aryl with at least one sixteenth of the Ar's containing a methylol bond per molecule, A is a hydrocarbylene bridging group comprising, for example, alkylene, arylene, two arylene groups joined by a bridging group, and n is one or greater. It is preferred that A is a compound with at least one sixteenth of the A molecules having at least one methylol bond per molecule. A is preferably resorcinol or bisphenol A with at least one sixteenth of the molecules containing methylol bonds. It is also preferred that Ar is methylol phenol with one sixteenth of the phenol's having at least one methylol bond.

A typical procedure to prepare a methylol poly (hydrocarbylene aryl phosphate) is to first react POCl₃ with methylol phenol to form either methylol mono-phenyl di-chlorophosphate or methylol di-phenyl di-chlorophosphate depending on the molar ratio. A combination of methylol mono-phenyl di-chlorophosphate and methylol di-phenyl di-chlorophosphate are reacted with an aromatic diol that contains methylol bonds such as resorcinol, bisphenol A, or hydroquinone.

A partial list of suitable common polyhydric materials applicable to the invention include pentaerytiritol, dipentaerythritol, tripentaerytiritol, dextrin, sorbital, resorcinol, naphthalenediol, hydroquinone, catechol, ethylene glycol, propylene glycol, diethylene glycol, polyethylene glycols, and glycerol. A partial list of suitable applicable alcohols include methanol, ethanol, buthanol, hexanol, octanol, ethylene glycol, butylene glycol, and propylene glycol.

Flame retardants are generally added to materials so that the material passes a particular flame retardance test. The test dictates the level of flame retardance and thus the level of addition. It is difficult to specify the amount that will be necessary as one might choose a methylol urea for a particular application, because it is cheaper than methylol melamine even though a higher loading might be needed. Many considerations are application dependent.

A best practice can not be formulated beforehand. Polymers decompose with heat at different temperatures thus requiring the FR agent to be chosen with that information in hand. Polypropylene with little inherent char formation will flame retard differently than a polyester or a polyamide. Polymers within these families can behave very differently. Examples have been chosen to demonstrate the breadth of FR compounds that can be synthesized. The most preferred is the reaction products of methylol urea and methylol melamine with phosphoric acid, pyrophosphoric acid, or polyphosphoric acid and will provide the best balance of cost and FR performance.

Many of the FR agents of this invention intumesce when exposed to 500° C. in an oven, that is decomposition with formation of foam. We use these conditions as our test of intumescence. These compounds fulfill the objective of being self-intumescing. These compounds behave similarly as to when an acid, polyol and blowing agent are mixed together and exposed to 500° C. in an oven. Heat will cause these compounds to become intumescent when incorporated into coatings or polymers which will reduce the flammability of the articles that contain this ingredient. For the reaction products made with strong acids, a large intumescence will be observed. A weak intumescence will be observed for reaction products made with weak acids such as cyanuric acid or boric acid.

The reaction product of this invention can be added to synthetic polymers, both thermoplastic and thermoset as well as polymeric coatings and paints. The field of applicability is not limited. The applicable thermoplastic polymers should have a melting point or substantial softening point greater than 80° C. Some polymers soften at temperatures well below their melt point and can be processed at the softening temperature.

Polymer compositions of the present invention can be prepared conventionally in a melt mixer such as a Brabender mixer, a single screw extruder, a twin screw extruder, or any other such devise that melts polymer and allows addition of additives. A Brabender will be preferred for polymers with poor thermal behavior. An extruder is often used for more stable polymers with high melt point.

From a practical standpoint, it is useful and very desirable to pelletize powders so that large scale users can maintain a dust free environment for workers. Pellets are also very easy to feed to high volume extruders. There are a number of pelletizing machines available commercially, with such approaches described in Encyclopedia of Chemical Technology, Fourth Edition. Liquids applied to powders bind particles together via a capillary action. The binding force can be increased by intermolecular forces. The methylol amine and methylol phenol solutions can be used to pelletize the compounds of this invention as these solutions improve intermolecular forces as they can bridge the particles. These solutions will adhere readily to the surface of the powders and provide a path for interaction between neighboring molecules on different particles. The moisture will evaporate with drying and leave agglomerated powders. The advantage filled here is that the solutions such as methylol melamine help compact powders without sacrificing the flame resistance. Our preferred practice is methylol melamine with one to three methylol bonds per melamine. The concentration of melamine in the solutions can range from 0.1% to 20%. It is necessary to wet at least one half of the particles with our solution and then apply pressure between particles. The next step is drying to remove solvent at an appropriate temperature for that solvent.

The polymer composition containing the reaction products of this invention may contain other additives such as other flame retardants, standard carbon forming compounds, and re-enforcing agents such as chopped glass, aramid fibers, mica, or clay. Since flame retardants work by different mechanisms, a combination of our FR agent with other FR agents may perform more efficiently. Other additives to polymer compositions include such ingredients as stabilizers, release agents, flow agents, dispersants, plasticizers, and pigments.

The heat treatment makes the compounds more thermally stable and can usually create a more hydrophobic surface as indicated by decreasing solubility in water. Some applications requiring higher thermal stability or low solubility may use an FR agent of this invention that has been heat treated. The preferred heat treatment is any temperature less than 340° C. for less than 60 minutes.

The range of application of the compositions of this invention can be enlarged by decreasing the particle size by milling in a monomer or solvent. The milled compound in the monomer can then be added to the process for making the polymers containing that monomer and thereby making a polymeric composition that includes an FR agent. Examples include thermoplastic and thermoset polymers such as polyesters, polyamides, polyolefins, polyurethanes, and their co-polymers.

Heat treatment at temperatures less than 360° C. can be done in various methods. Any method whereby the heat is applied somewhat uniformly to all the particles is important. Standard ovens and fluidized beds are examples.

A convenient method to grind the materials of this invention is a fluidized Bed Jet Mill made by the Condux Co, Hanau, Germany. There are numerous dry grinding techniques and we are not limited to the Condux design. Another option is wet grinding in a solvent and then drying. Or, grind in a monomer and proceed with polymerization at the desired concentration. A media mill by Netzsch Inc, Exton, Pa. is found to work exceedingly well for wet grinding. A review of drying technology and grinding technology applicable to this invention can be found in the Encyclopedia of Chemical Technology, fourth edition.

The compounds of this invention may require coating with 0.1% to 1% by weight of organo functional silanes or other known compatibilizers to facilitate uniform distribution within the material or materials being flame retarded. Organo functional silane treatments for coating of the compounds of this invention are available from Witco Corp., Greenwich, Conn. These include the following products and their chemical descriptions when disclosed from Witco corp: A-137-octyltriethoxysilane, A-162-methyltriethoxysilane, A-163-methyltrimethoxysilane, A-1230-proprietary nonionic silane dispersing agent, Y-1 1597-tris-[3-(trimethoxysilyl)propyl]isocyanurate, RC-1-proprietary, A-151-vinyltriethoxysilane, A-171-vinyltrimethoxysilane, A-172-vinyl-tris-(2-methoxyethoxy) silane, A-2171-vinylmethyldimethoxysilane, A-174-gamma-methacryloxypropyltrimethoxysilane, A-186-beta-(3,4-epoxycyclohexyl)ethyltrimethoxysilane, A-187-gamma-glycidoxypropyltrimethoxysilane, A-189-gamma-mercaptopropyltrimethoxysilane, RC-2-proprietary polysulfidesilane, A-1289-bis-(3-[triethoxisilyl]-propyl)-tetrasulfane, A-1100-gamma-aminopropyltriethoxysilane, A-1101-gamma-aminopropyltriethoxysilane, A-1102-gamma-aminopropyltriethoxysilane, A-1106-aminoalkyl silicone solution, A-1108-monified aminoorganosilane, A-1110-gamma-aminopropyltrimethoxysilane, A-1120-n-beta-(aminoethyl)-gamma-aminopropyltrimethoxysilane, A-1126-modified aminoorganosilane (40% in methamol), A-1128-modified aminosilane (50% in methanol), A-1130-triaminofinctional silane, A-1170-bis-(gamma-trimethoxysilylpropyl)amine, Y-9669-n-phenyl-gamma-aminopropyltrimethoxysilane, Y-11343-organomodified polydimethylsiloxane, A-1387-polyazamide silane (50% in methanol), A-2120-n-beta-(aminoethyl)-gamma-aminopropylmethyldimethoxysilane, A-1160-gamma-ureidopropyltrialkoxysilane (50% in methanol), Y-11542-gamma-ureidopropyltrimethoxysilane, and A-1310-gamma-isocyanatopropyltriethoxysilane.

The compounds of this invention tend to have acidic properties which could be detrimental in certain applications with polymers. The compounds can be coated with organic bases such as ethylene diamine or standard bases such as ammonium hydroxide, sodium hydroxide, or calcium hydroxide.

The classes of polymers to which the compositions of this invention are applicable include the following: acrylic, butyl, cellulosics, epoxy, furan, melamine, neoprene, nitrile, nitrocellulose, phenolic, polyamide, polyester, polyether, polyolefin, polysulfide, polyurethane, polyvinyl butyral, silicone, styrene-butadiene, and vinyl.

Polymer and polymer compositions to which the compositions of this invention are applicable to include the following:

1. Mono and diolefins such as polypropylene(PP), polyisobutylene, polymethylpentene, polyisoprene, polybutadiene, polyethylene with or without crosslinking, highdensity polyethylene, low density polyethylene, or mixtures of these polymers. Copolymers of mono and diolefins including other vinyl momomers such as ethylene-propylene copolymers, ethylene-vinyl acetate copolymers. Terpolymers of ethylene with propylene and a diene such as hexadiene, cyclopentadiene or ethylidiene norborene and vinyl monomers such as vinyl acetate. Mixtures of polymers under 1.

2. Polystyrene, poly α methyl styrene, poly a methylstyrene, and copolymers of styrene or α methylstyrene with dienes or acryl derivatives such as styrene-butadiene, styrene-actrylonitrile, styrene-alkylmethylacrylate, styrene-butadiene-akylacrylate, styrene-maleic anhydride, and styrene-acrylonitrile-methylacrylate.

3. Polyphenylene oxide and polyphenylene sulfide and their mixtures with styrene polymers or with polyamides.

4. Polyurethanes derived from polyethers, polyesters and polybutadiene with terminal hydroxy groups on one hand and aliphatic or aromatic polyisocyanates on the other as well as their precursors.

5. Polyamides and copolymers derived from diamines and dicarboxylic acids and/or from arninocarboxylic acids or the corresponding lactams, such as polyamide 4, polyamide 6, polyamide 6/6, 6/10, 6/12, 4/6, 66/6, 6/66, polyamide 11, polyamide 12, aromatic polyamides based on aromatic diamine and adipic acid: and iso- and/or terephthalic acid and optionally an elastomer as modifier, for example poly-2,4-trimethyl hexamethylene terephthalamide, poly m phenylene-isophthalamide.

6. Polyesters derived from dicarboxylic acids and dialcohols and/or from hydrocarboxylic acids or the corresponding lactones such as polyethylene terephthalate, polybutylene terephthalate, polyethylene terephthalate/polybutylene terephthalate mixtures, polyethylene terephthalate/polybutylene terephthalate coploymers, poyl 1,4-dimethyl clclohexane terephthalate, polyhydroxybenzoates, and co-ploymers with ethylene.

7. Polyvinyl chloride and copolymers with ethylene, copolymers of tetra fluro ethylene and ethylene.

8. Thermoset polymers include for example unsaturated polyester resins, saturated polyesters, alkyd resins, amino resins, phenol resins, epoxy resins, diallyl phthalate resins, as well as polyacrylates and polyethers containing one or more of these polymers and a crosslinking agent. A review of thermosets is found in Ullmann's Encyclopedia of Industrial Chemistry, Vol A26, p 665

9. Polymers for insulation such as fluorinated ethylene-propylene (FEP), cross linked polyethylene (XLPE), ethylene-propylene rubber(EPR), tree cross linked polyethylene (TRXLPE), and ethylene vinyl acetate (EVA).

10. Cellulose acetate, flexible polyurethane, rigid polyurethane.

11. Fluoropolymers and co-polymers such as Tefzel®, DuPont Co, Wilmington, Del. Elastomers such as spandex as defined in Encyclopedia of Chemical Technology. Polyimides such as Kapton®, DuPont Co., Wilmington, Del. And defined in Encvclopedia of Chemical Technology.

Melamine pyrophosphate and mono, di-, or tri-pentaerythritol are commonly used together (see U.S. Pat. No. 3,914,193) with a film forming latex of a poly(vinyl ester) to form an intumescent latex coating composition or intumescent paint. Such latexes can be in aqueous or alcohol mediums. An improvement is to use the self intumescing reaction products of this invention with the latex binder to form coatings or paints that are flame retardant coatings. A usable coating can contain one or more of the other ingredients such as potassium tripolyphosphate, ethhoxylated castor oil, waxy-fatty ester de-foamer, chlorinated paraffm, TiO₂, and hydroxy ethyl cellulose which are normally ingredients in flame retardant paints. One skilled in the art of coatings can easily add the correct combinations to get proper physical behavior of a coating with the compounds of this invention.

The materials of this invention have value for flame retarding articles, films, and fibers.

### EXAMPLES

Abbreviations Used in Examples:

Mel-melamine, pform-paraformaldehyde, SAPP-sodium acid pyrophosphate, ixr-ion exchange resin, wash-water used to wash resin, HEXP-sodium polyphosphate, ID#- sample identification, SMB-sodium metaborate, DYD-dicyanodiamide, pTSA-p toluene sulfonic acid, THPC-80% aqueous solution of tetrakis hydroxy methyl phosphonium chloride, PHYT-phytic acid, dodecasodium salt hydrate, NNS2-naphthalenedisulfonic acid, disodium salt, NNS1-naphthalenesulfonic acid, sodium salt, penta-pentaerythritol.

Sources of Materials:

Sodium acid pyrophosphate and sodium polyphosphate were obtained from FMC Corporation, Philadelphia, Pa. Ion exchange resin was obtained from Rhom and Haas, Philadelphia, Pa. Melamine and melamine cyanurate were obtained from DSM Corp., Saddlebrook, N.J. Urea, sodium salt of phytic acid, disodium salt of naphthalenedisulfonic, sodium salt of naphthalenesulfonic acid, tetrakis hydroxy methyl phosphonium chloride, dicyanodiamide, toluene acids, sodium meta borate, sodium salt of phytic acid, disodium salt of naphthalenedisulfonic acid, sodium salt of naphthalenesulfonic acid, tetrakis hydroxy methyl phosphonium chloride, and dicyanodiamide were obtained from Aldrich Chemical, Milwauke, Wis.

All of the ingredients for the examples demonstrating some of the reaction products of this invention are listed in tables and a similar experimental procedure was usually followed. Abbreviations used in the table are listed above. The first entry in the tables is always the sample ID. In tables I and II, the amount in grams of the amine, paraformaldehyde, and water are the first three entries after the sample designation. The amine compound and the paraformaldehyde were dissolved in water at a temperature of approximately 75° C.-100° C. The amounts of these ingredients and temperature were chosen so that a clear solution was obtained. The next four entries in grams are the amounts of sodium salt of the acid, the amount of water to dissolve or suspend the salt, the amount of ion exchange resin in hydrogen form, and amount of water to wash the resin. The ion exchange resin was added to the sodium salt solution or mixture and then stirred for about 15 minutes to remove nearly all the sodium and thereby the acid was formed. The ixr was removed by filtration and then washed with the wash water. The wash water contained acid and was added to the acid solution. Nearly all the tables have a column labeled foam which designates the level of intumescent char that forms when heated in an oven at 500° C. The pH of a 10% aqueous dispersion/solution was listed in the last column for some tables.

For the examples of table III, the first 6 entries after sample ID formed two separate clear solutions which were mixed together and then added to the acid solution formed from columns 8-11. For the examples of table IV, TSA was added to the acid solution. Mel, pform and water were heated and reacted as in table I. Tables V, VI, and VII follow the procedure of table I. For the examples of Table VIII, the first six entries after the sample ID formed two separate clear solutions which were mixed together to make the methylol compound and then reacted with the acid. For the examples of Tables IX and X, SMB and SAPP were mixed together to prepare the acids. For the examples of Table XI, the first 6 entries after the ID formed two separate clear solutions which were mixed together to prepare the methylol amine. For the examples of Table XII, the first six entries after the sample ID formed the methylol amine and the last 6 were used for preparation of the acid. Table XIII is similar to table I in the mixing of the ingredients. For the example of Table XIV, methylol melamine prepared from entries 3-5 was added to a solution of THPC. For the examples of Tables XV and XVI, NNS2 and NNS1, respectively, were added to the acid preparation. In table XVII, phytic acid and methylol melamine were reacted.

To iterate our experimental procedure for nearly all the examples, the acid solution was at room temperature and the methylol amine solution was at about 75° C.-100° C. when it was slowly added to the acid solution. The hot amine solution was added slowly over a period of 3 to 5 minutes into the acid solution which was stirred on a hot plate so that the final temperature was near 90° C. after mixing for about 30 to 60 minutes. It was important that the amine was added to the acid slowly as addition of acid to amine sometimes resulted in precipitation of a condensed resin instead of a reaction product. The solution was left on the hot plate for at least 30 to 60 minutes to raise the temperature to about 90° C. The reaction products resulting from addition of the amine to the acid were extracted in two ways which seemed to give equivalent results. The solution could be filtered to extract the reaction product. Reaction products based on urea have substantial solubility and would only be partially extracted by filtration as they remained in solution. Melamine based reaction products with low solubility were effectively extracted by filtration. A more time consuming method is to place the entire solution into a vacuum oven at moderate temperature for complete extraction, high yield, and no waste stream. After drying, the reaction product was heated at 100° C. to 150° C. for 30 minutes for curing. The intumescence behavior of the reaction products was similar for both drying procedures. The next to last entry will indicate if the intumescence observed was poor or good. The pH of a 10% solution of the reaction product is shown in the last column for some of the tables.

The above procedure may need some revision if the reaction is proceeding either too fast or too slow so that a resin is forming instead of the reaction product. A person knowledgeable in this chemistry would know how to revise the above experimental procedure. Example 1 serves as further demonstration of the experimental procedure for many of the examples in the tables.

### Example 1

Sample 4D in Table I was prepared by mixing 37.9 g melamine and 10.4 g paraformaldehyde in 170 g H₂O and heated with stirring at 90 C. for about 15-30 minutes. In a separate vessel, eighteen grams of SAPP was dissolved in 150 g H₂O. The next step was to add 60 g of ion exchange resin to remove sodium ions and make pyrophosphoric acid (PPA). The acid was filtered to remove the ion exchange resin. The resin was washed with 25 g H₂O, with said wash water added to the PPA acid. Then slowly (over 3-5 minutes), the clear methylol melamine solution was added to the PPA acid solution. A white precipitate was formed nearly immediately as the second solution was added. The precipitate was filtered and dried, and then heated at 120° C. for 30 minutes. The pH of the reaction product was approximately 5.1. Two g of the reaction product was heated in an oven at 500° C. The char that formed was several times larger due to self-intumescence and thus demonstrated the FR effect. MPP heated in a similar manner did not foam which demonstrated the novelty of the methylolated compounds.

To further test the FR behavior for polymers, a second experiment was to mix 1 g of powdered polyethylene with 1 g of sample 4D. The sample was placed in an aluminum pan and then in an oven at 500° C. The sample caught fire in about 200 seconds, the average of three runs. A comparison experiment was to mix 1 g of powdered polyethylene with 0.7 g of melamine pyrophosphate and 0.3 g of dipentaerythritol and mix thoroughly and then place in an oven at 500° C. The sample caught fire in the oven after about 90 seconds, a much shorter time than the similar experiment using polyethylene with the reaction product 4D. The sample with 4D also stopped burning in shorter time than the MPP/depentaerythritol/polyethylene sample. This test demonstrated the superior FR behavior of sample 4D.

TABLE I
The reaction product of methylol melamine with pyrophosporic acid.

| ID#- | Mel- | pform | H2O | SAPP | H2O | ixr | wash | foam | pH |
|---|---|---|---|---|---|---|---|---|---|
| 4D | 37.9 | 10.4 | 170 | 18.0 | 150 | 60 | 25 | good | 5.1 |
| 4e | 37.8 | 11.5 | 151 | 18.0 | 150 | 59 | 25 | good | 5.8 |
| 4f | 75.6 | 22.9 | 300 | 36.1 | 300 | 120 | 50 | good | 5.0 |
| 4I | 75.6 | 17.8 | 360 | 36.2 | 300 | 120 | 50 | good | 5.4 |
| 4j | 75.6 | 18.5 | 340 | 36.2 | 300 | 120 | 50 | good | 4.7 |
| Pya | 37.8 | 8.9 | 174 | 16.7 | 150 | 70 | 35 | good | 5.6 |
| Pyb | 37.8 | 8.9 | 172 | 17.6 | 126 | 100 | 35 | good | 5.4 |
| Pyc | 37.8 | 8.9 | 170 | 18.5 | 125 | 60 | 35 | good | 5.5 |
| Pyd | 37.8 | 8.9 | 171 | 18.7 | 125 | 70 | 35 | good | 5.4 |
| Pye | 28.4 | 6.7 | 128 | 14.1 | 94 | 75 | 27 | good | 4.4 |
| Pyf | 75.6 | 17.8 | 341 | 37 | 250 | 200 | 70 | good | 5.2 |
| Mp15 | 37.8 | 8.8 | 402 | 35 | 250 | 100 | 50 | good | 4.4 |
| Mp16 | 37.8 | 8.8 | 402 | 35 | 250 | 100 | 50 | good | 4.6 |
| Mp17 | 37.8 | 8.8 | 402 | 34.5 | 250 | 100 | 50 | good | 4.5 |
| Mp18 | 37.8 | 8.8 | 402 | 34.5 | 250 | 100 | 50 | good | 4.5 |
| Mp19 | 37.8 | 8.8 | 402 | 33 | 250 | 100 | 50 | good | 4.6 |
| Mp20 | 37.8 | 8.8 | 402 | 33 | 250 | 100 | 50 | good | 4.6 |
| Mp21 | 37.8 | 8.8 | 405 | 31 | 250 | 100 | 50 | good | 4.4 |
| Mp22 | 37.8 | 8.8 | 406 | 31 | 250 | 100 | 50 | good | 4.1 |
| 1v | 12.6 | 3 | 101 | 11.1 | 90 | 53 | 25 | good | |
| 2v | 19 | 4.5 | 151 | 11.1 | 90 | 53 | 25 | good | |
| 3v | 19 | 4.5 | 101 | 11.1 | 90 | 53 | 25 | good | 5.5 |
| 4v | 19 | 4.5 | 126 | 11.1 | 90 | 53 | 25 | good | |
| 5v | 19 | 4.5 | 101 | 11.1 | 90 | 53 | 25 | good | |
| 6v | 19 | 4.5 | 101 | 11.1 | 90 | 53 | 25 | good | |
| 9v | 19 | 4.5 | 101 | 11.1 | 90 | 53 | 25 | good | |
| 16v | 19 | 4.5 | 101 | 11.1 | 60 | 53 | 25 | good | |
| 17v | 19 | 4.5 | 101 | 11.1 | 75 | 53 | 25 | good | |
| 18v | 19 | 4.5 | 101 | 11.1 | 54 | 53 | 25 | good | |

TABLE II
The reaction product of methylol metlamine with polphosphoric acid.

| ID#- | Mel- | pform | H2O | HEXP | H2O | ixr | wash | foam | pH |
|---|---|---|---|---|---|---|---|---|---|
| pp1 | 17.7 | 4.2 | 67 | 13.5 | 106 | 30 | 25 | good | 4.5 |
| pp2 | 9 | 2.1 | 43 | 13.5 | 93 | 30 | 15 | good | 4.5 |
| pp3 | 37.8 | 8.9 | 170 | 25.5 | 75 | 60 | 25 | good | 5.6 |
| pp4 | 37.8 | 8.9 | 170 | 25.5 | 75 | 60 | 25 | good | 4.7 |

TABLE III
The reaction product of methylol dicyandiamide and methylol melamine
with pyrophosphoric acid.

| ID# | DYD | pform | H2O | Mel- | pform | H2O | SAPP | H2O | ixr | wash | foam |
|---|---|---|---|---|---|---|---|---|---|---|---|
| Dmp1 | 4.2 | 1.5 | 35 | 6.3 | 1.5 | 68 | 11.1 | 90 | 50 | 25 | good |
| Dmp2 | 2.1 | .75 | 20 | 9.5 | 2.3 | 101 | 11.1 | 90 | 50 | 25 | good |
| Dmp3 | 4.2 | 1.5 | 35 | 9.5 | 2.3 | 101 | 11.1 | 90 | 50 | 25 | good |
| Dmp4 | 2.1 | .75 | 20 | 9.5 | 2.3 | 101 | 11.1 | 90 | 50 | 25 | good |
| Dmp5 | 2.1 | .75 | 20 | 9.5 | 2.3 | 101 | 11.1 | 90 | 50 | 25 | good |
| Dmp6 | 4.2 | 1.5 | 35 | 9.5 | 2.3 | 101 | 11.1 | 90 | 50 | 25 | good |
| Dmp7 | 4.2 | 1.5 | 35 | 9.5 | 2.3 | 101 | 11.1 | 90 | 50 | 25 | good |
| Dmp8 | 2.1 | .75 | 20 | 9.5 | 2.3 | 101 | 11.1 | 90 | 50 | 25 | good |
| Dmp9 | 4.2 | 1.5 | 35 | 9.5 | 2.3 | 101 | 11.1 | 90 | 50 | 25 | good |
| Dm10 | 6.3 | 2.25 | 50 | 9.5 | 2.3 | 101 | 11.1 | 90 | 50 | 25 | good |
| Dm11 | 0 | 0 | 0 | 12.6 | 3 | 101 | 11.1 | 90 | 50 | 25 | good |
| Dm12 | 0 | 0 | 0 | 19 | 4.5 | 151 | 11.1 | 90 | 50 | 25 | good |
| Dm13 | 4.2 | 1.5 | 35 | 9.5 | 2.3 | 101 | 11.1 | 90 | 50 | 25 | good |
| Dm14 | 2.1 | .75 | 20 | 9.5 | 2.3 | 101 | 11.1 | 90 | 50 | 25 | good |
| Dm15 | 0 | 0 | 0 | 12.6 | 3 | 101 | 11.1 | 90 | 50 | 25 | good |
| Dm16 | 0 | 0 | 0 | 19 | 4.5 | 151 | 11.1 | 90 | 50 | 25 | good |

TABLE IV
The reaction product of methylol melamine with pyrophosphoric acid and p
toluene sulfonic acid.

| ID# | TSA | Mel- | pform | H2O | SAPP | H2O | ixr | wash | foam | pH |
|---|---|---|---|---|---|---|---|---|---|---|
| 7v | 2 | 19 | 4.5 | 101 | 11.1 | 90 | 53 | 25 | good | 4.6 |
| 8v | 2 | 19 | 4.5 | 101 | 11.1 | 90 | 53 | 25 | good | |
| 9v | 4 | 19 | 4.5 | 101 | 11.1 | 90 | 53 | 25 | good | |
| 10v | 4 | 19 | 4.5 | 101 | 9 | 70 | 53 | 25 | good | |
| 11v | 2 | 19 | 4.5 | 101 | 10 | 90 | 53 | 25 | good | |
| 13v | 3 | 19 | 4.5 | 101 | 9 | 70 | 53 | 25 | good | |
| 19v | .5 | 19 | 4.5 | 101 | 11.1 | 50 | 53 | 25 | good | |
| 20v | .25 | 19 | 4.5 | 101 | 11.1 | 50 | 53 | 25 | good | |
| 21v | 0.75 | 19 | 4.5 | 101 | 11.1 | 50 | 53 | 25 | good | |
| 22v | 0.28 | 19 | 4.5 | 101 | 11.1 | 50 | 53 | 25 | good | |
| 23v | 0.6 | 19 | 4.5 | 101 | 11.1 | 50 | 53 | 25 | good | |
| 24v | 0.3 | 19 | 4.5 | 101 | 11.1 | 50 | 53 | 25 | good | |

TABLE V
The reaction product of methylol melamine with metaboric acid.

| ID# | Mel- | pform | H2O | SMB | H2O | ixr | wash | foam |
|---|---|---|---|---|---|---|---|---|
| Mb1 | 18.9 | 4.4 | 202 | 15.25 | 75 | 97 | 75 | poor |
| Mb2 | 18.9 | 4.4 | 202 | 15.25 | 150 | 97 | 75 | poor |
| Mb3 | 18.9 | 4.4 | 202 | 15.25 | 75 | 97 | 75 | poor |
| Mb4 | 18.9 | 4.4 | 202 | 15.25 | 81 | 97 | 75 | poor |

TABLE VI
The reaction product of methylol urea with pyrophosphoric acid.

| ID# | Urea- | pform | H2O | SAPP | H2O | ixr | wash | foam |
|---|---|---|---|---|---|---|---|---|
| Up1 | 16.8 | 8.4 | 125 | 31 | 250 | 100 | 70 | good |
| Up2 | 16.8 | 5.5 | 250 | 31 | 250 | 100 | 70 | good |
| Up3 | 16.8 | 8.4 | 250 | 15.5 | 125 | 100 | 70 | good |

TABLE VII
The reaction product of methylol urea with metaboric acid

| ID# | Urea- | pform | H2O | SMB | H2O | ixr | wash | foam |
|---|---|---|---|---|---|---|---|---|
| Ub1 | 18.3 | 9.1 | 200 | 31 | 200 | 60 | 100 | poor |
| Ub2 | 9.2 | 4.6 | 100 | 15.5 | 75 | 60 | 50 | poor |

TABLE VIII
The reaction product of methylol melamine and methylol urea with
pyrophosphoric acid.

| ID# | Mel | pform | H2O | Urea- | pform | H2O | SAPP | H2O | ixr | wash | foam |
|---|---|---|---|---|---|---|---|---|---|---|---|
| Mup1 | 12.6 | 3 | 135 | 6 | 3 | 50 | 22.2 | 179 | 70 | 25 | good |
| Mup2 | 6.3 | 1.5 | 63 | 9 | 4.5 | 75 | 22.2 | 179 | 70 | 25 | good |
| Mup3 | 18.9 | 4.5 | 202 | 3 | 1.5 | 25 | 22.2 | 179 | 70 | 35 | good |

TABLE IX
The reaction product of methylol melamine with metaboric acid and
pyrophosphoric acid.

| ID# | Mel | pform | H2O | SMB | H2O | SAPP | H2O | ixr | wash | foam |
|---|---|---|---|---|---|---|---|---|---|---|
| Mbp1 | 25.2 | 6 | 270 | 10.2 | 51 | 22.2 | 179 | 100 | 50 | little |
| Mbp2 | 25.2 | 6 | 270 | 5.1 | 26 | 16 | 135 | 75 | 35 | little |
| Mbp3 | 25.2 | 6 | 270 | 15.3 | 76 | 5.6 | 45 | 75 | 35 | little |

TABLE X
The reaction product of methylol urea with metaboric acid and
pyrophosphoric acid.

| ID# | Urea | pform | H2O | SMB | H2O | SAPP | H2O | ixr | wash | foam |
|---|---|---|---|---|---|---|---|---|---|---|
| Ubp1 | 12 | 6 | 48 | 10.2 | 51 | 11.1 | 90 | 75 | 35 | little |
| Ubp2 | 12 | 6 | 48 | 5.1 | 26 | 16.7 | 135 | 75 | 35 | little |
| Ubp3 | 12 | 6 | 48 | 15.3 | 76 | 5.6 | 45 | 75 | 35 | little |

TABLE XI
The reaction product of methylol melamine and methylol urea with
metaboric acid.

| ID# | Mel | pform | H2O | Urea- | pform | H2O | SMB | H2O | ixr | wash | foam |
|---|---|---|---|---|---|---|---|---|---|---|---|
| Mub1 | 6.3 | 1.5 | 63 | 3 | 1.5 | 25 | 10.2 | 51 | 60 | 35 | poor |
| Mub2 | 9.45 | 2.3 | 95 | 1.5 | .8 | 13 | 10.2 | 51 | 45 | 25 | poor |
| Mub3 | 3.15 | .75 | 32 | 4.5 | 2.3 | 38 | 10.2 | 51 | 45 | 30 | poor |

TABLE XII
The reaction product of methylol melamine and methylol urea with
metaboric acid and pyrophosphoric acid.

| ID# | Mel | pform | H2O | Urea- | pform | H2O | SMB | H2O | SAPP | H2O | ixr | wash |
|---|---|---|---|---|---|---|---|---|---|---|---|---|
| Mubp1 | 12.6 | 3 | 135 | 3 | 1.5 | 12 | 5.1 | 25.5 | 11.1 | 90 | 85 | 35 |
| 2 | 6.3 | 1.5 | 68 | 6 | 3 | 24 | 5.1 | 25.5 | 11.1 | 90 | 85 | 35 |
| 3 | 9.45 | 2.25 | 101 | 4.5 | 2.3 | 38 | 5.1 | 25.5 | 11.1 | 90 | 85 | 35 |

TABLE XIII
The reaction product of methylol dicyandiamide with pyrophosphoric acid

| D# | DYD- | pform | H2O | SAPP | H2O | ixr | wash | foam |
|---|---|---|---|---|---|---|---|---|
| Dp1 | 8.4 | 3 | 75 | 11.1 | 90 | 50 | 25 | good |
| Dp2 | 12.6 | 4.5 | 60 | 11.1 | 90 | 50 | 25 | good |
| Dp3 | 16.8 | 6 | 100 | 11.1 | 90 | 50 | 25 | good |

TABLE XIV
The reaction product of methylol melamine with THPC.

| | | | | | | |
|---|---|---|---|---|---|---|
| ID# | THPC | Mel- | pform | H2O | foam | pH |

| | | | | | |
|---|---|---|---|---|---|
| 11v | 23.9 | 12.6 | 3 | 67 | good |

TABLE XV
The reaction product of methylol melamine with naphthalenedisulfonic
acid and pyrophosphoric acid.

| ID# | NNS2 | Mel- | pform | H2O | SAPP | H2O | ixr | wash | foam |
|---|---|---|---|---|---|---|---|---|---|
| N1mp | .6 | 19 | 4.5 | 101 | 11.1 | 50 | 53 | 25 | good |
| N2mp | .6 | 19 | 4.5 | 101 | 11.1 | 50 | 53 | 25 | good |

TABLE XVI
The reaction product of methylol melamine with naphthalenesulfonic acid
and pyrophosphoric acid.

| ID# | NNS1 | Mel- | pform | H2O | SAPP | H2O | ixr | wash | foam |
|---|---|---|---|---|---|---|---|---|---|
| N3mp | 0.6 | 19 | 4.5 | 101 | 11.1 | 50 | 53 | 25 | good |

TABLE XVII
The reaction product of methylol melamine with phytic acid.

| ID# | Mel- | pform | H2O | PHYT | H2O | ixr | wash | foam |
|---|---|---|---|---|---|---|---|---|
| P1mp | 19 | 4.5 | 101 | 9.2 | 50 | 90 | 25 | good |
| P2mp | 11.4 | 2.7 | 61 | 9.2 | 50 | 90 | 25 | good |

### Example 2

### Preparation of methylol melamine cyanurate (MMC)

18.9 g of melamine and 4.4 g of paraformaldehyde with 202 g H₂O were heated to approximately 100° C. with stirring. A clear solution of methylol melamine was formed in about 20 minutes. In a separate beaker, 19.3 g. cyanuric acid (CA) was added to 125 g H₂O and heated to about 80° C. The hot methylol melamine solution was slowly added to the CA slurry over about 4 minutes maintaining good agitation. After about 30 minutes the reaction was complete and the pH of the final solution was about 4.7. The product was filtered and dried.

| Id# | Mel | paraf | H2O | CA | H2O | pH |
|---|---|---|---|---|---|---|
| Mc1 | 18.9 | 4.4 | 202 | 19.3 | 125 | 4.7 |

In table XVIII, the thermogravimetric (TGA) weight was tabulated as a function of temperature for melamine cyanurate (MC) and MMC. The heating rate was 10° C. per minute for a nitrogen flow rate of 30 cubic centimeters/minute. Both samples did not begin to loose weight until the temperature had reached about 250° C. At 300° C., the weight remaining was nearly identical. Overall, the MMC lost weight a little faster than the MC. This represented an earlier release of volatiles at a lower temperature which should enhance FR behavior for polymers and materials that decompose at such temperatures.

TABLE XVIII
Comparison of TGA data for methylol melamine cyanurate with the
conventional melamine cyanurate from DSM Corp. The weight remaining was
tabulated as a function of temperature 100° C. and higher.

| TGA | 100° C. | 200° C. | 250° C. | 300° C. | 350° C. | 400° C. | 450° C. | 500° C. |
|---|---|---|---|---|---|---|---|---|
| Mmc | 100 | 99 | 99 | 98 | 91 | 51 | 8.5 | 2.7 |
| Mc | 99.9 | 99.9 | 99.8 | 99.3 | 94 | 64.1 | 5.8 | 4.6 |

### Example 3

### Preparation of methylol melamine pentaerythritol phosphate

Mix 18.9 g (0.15 moles) melamine and 4.4 g of paraformaldehyde with 202 g H₂O and heat to approximately 100° C. with stirring. A clear solution of methylol melamine forms in about 20 minutes. Pentaerythritol phosphate is prepared separately according to U.S. Pat. No. 3,293,327. In a separate beaker, add 27 g pentaerythritol phosphate (0.15 moles) to 125 g H₂O and heat to about 80° C. Slowly add the hot methylol melamine solution to the pentaerytiritol phosphate over about 4 minutes maintaining good agitation. After about 30 minutes the reaction is complete and the pH of the final solution is about 4.7. Filter and dry the product.

### Example 4

### Preparation of methylol melamine trimethylol-ethane phosphate

Mix 18.9 g (0.15 moles) melamine and 4.4 g of paraformaldehyde with 202 g H₂O and heat to approximately 100° C. with stirring. A clear solution of methylol melamine forms in about 20 minutes. Trimethylol-ethane phosphate is prepared separately according to U.S. Pat. No. 3,293,327. In a separate beaker, add 22.2 g trimethylol-ethane phosphate (0.15 moles) to 125 g H₂O and heat to about 80° C. Slowly add the hot methylol melamine solution to the trimethylol-ethane phosphate/water over about 4 minutes maintaining good agitation. After about 30 minutes the reaction is complete and the pH of the final solution is about 4.7. Filter and dry the product.

### Example 5

### Alternative Preparation methylol melamine Compound of pyrophosphoric Acid

Three g of paraformaldehyde was dissolved in 12 g H₂O with application of some heat. In a separate vessel, 11.1 g of SAPP was partially dissolved in 50 g H₂O. The next step was to add 60 g of ion exchange resin to remove sodium ions and make pyrophosphoric acid (PPA). The acid was filtered to remove the ion exchange resin. The resin was washed with 25 g H₂O, with said wash water added to the PPA acid. The PPA acid was heated to 60° C.-85° C. and then 12.6 g of melamine was added as well as the formaldehyde solution. Heating and mixing was continued until the reaction was complete and the methylol melamine compound of pyrophosphoric acid had been formed. The precipitate was filtered and dried and then heated at 110° C. for 30 minutes. Two g of the reaction product was heated in an oven at 500° C. The char that formed was several times larger due to self-intumescence.

### Example 6

### Preparation of ethylene diamine Compound of pyrophosphoric Acid

In a separate vessel, 11.1 g of SAPP was partially dissolved in 50 g H₂O. The next step was to add 60 g of ion exchange resin to remove sodium ions and make pyrophosphoric acid (PPA). The acid was filtered to remove the ion exchange resin. The resin was washed with 25 g H₂O, with said wash water added to the PPA acid. The PPA solution was heated to about 50° C. and then slowly 6 g ethylene diamine was added over about 6 minutes. The mixing was continued for about 30 minutes, then filtered and dried.

### Example 7

### Preparation of methylol ethylene diamine Compound of pyrophosphoric Acid

1.5 g of paraformaldehyde was dissolved in 6 g H₂O with application of some heat. In a separate vessel, 11.1 g of SAPP was partially dissolved in 50 g H₂O. The next step was to add 60 g of ion exchange resin to remove sodium ions and make pyrophosphoric acid (PPA). The acid was filtered to remove the ion exchange resin. The resin was washed with 25 g H₂O, with said wash water added to the PPA acid. Six g of ethylene diamine was added to the formaldehyde solution to form methylol bonds. Ethylene diamine/formaldehyde solution was added slowly to PPA solution. The solution was heated to about 50° C., then filtered and dried.

### Example 8

### Preparation of Reaction Product of pentaerythritol and pyrophosphoric Acid

6.8 g of pentaerythritol was dissolved in 68 g of water by heating to near boiling. In a separate vessel, 11.1 g of SAPP was partially dissolved in 50 g H₂O. The next step was to add 60 g of ion exchange resin to remove sodium ions and make pyrophosphoric acid (PPA). The acid was filtered to remove the ion exchange resin. The resin was washed with 25 g H₂O, with said wash water added to the PPA acid. The PPA solution was heated in a three neck flask with an electric heating pad to about 80° C. The hot pentaerythritol solution was then added to the PPA solution. Vacuum was applied to the flask to remove water which took about 45 minutes. The reaction product of pentaerythritol and pyrophosphoric acid was a very viscous tan colored liquid. The liquid became a sold taffy-like substance on cooling. This compound expanded substantially when heated in an oven at 500C. thus demonstrating that it was self intumescing and could be used as an FR agent.

### Example 9

### Preparation of Reaction Product of methylol melamine with pentaerythritol and pyrophosphoric Acid with Ingredient Ratios Shown in Table XIX

Sample pmpp10 from table XIX will be discussed as a standard preparation of these examples. 3.5 g of pentaerythritol was dissolved in 35 g of water by heating to near boiling. Separately, 12.6 g melamine and 3.0 g of paraformaldehyde were mixed with 67 g H₂O and heated to approximately 100° C. with stirring. A clear solution of methylol melamine formed in about 20 minutes. In a separate vessel, 11.1 g of SAPP was partially dissolved in 50 g H₂O. The next step was to add 50 g of ion exchange resin to remove sodium ions and make pyrophosphoric acid (PPA) with pH of about 1.1. The acid was filtered to remove the ion exchange resin. The resin was washed with 25 g H₂O, with said wash water added to the PPA acid. The PPA solution was heated in a three neck flask with an electric heating pad to about 80° C. The hot pentaerythritol solution was added without removal of the water to the acid solution. The methylol melamine solution was slowly added to the pentaerythritol/PPA solution. Vacuum distillation was used to remove most of the water water which will take about 45 to 90 minutes. Further drying was done in a vacuum oven at about 110° C. so as to combine drying and heat treating. Sample Pmpp11, Table XIX was essentially prepared the same except no pentaerythritol was added. Some examples in Table XIX had aqueous formaldehyde (columns 4 and 5) added to the acid and pentaeryiritol solution which seemed to enhance intumescent foaming a little. All samples had substantial intumescence. Samples containing pentaerythritol had much stronger intumescence.

TABLE XIX
The reaction product of methylol melamine with pentaerythritol and
pyrophosphoric acid

| Pmpp | pent | H2O | pform | H2O | Mel | pform | H2O | sapp | H2O | ixr | wash |
|---|---|---|---|---|---|---|---|---|---|---|---|
| 1 | 6.7 | 67 | 1.5 | 15 | 6.3 | 1.5 | 35 | 11.1 | 50 | 50 | 25 |
| 2 | 6.7 | 67 | 1.5 | 15 | 6.3 | 1.5 | 35 | 11.1 | 50 | 50 | 25 |
| 3 | 6.7 | 67 | 1.5 | 15 | 9.5 | 2.25 | 50 | 11.1 | 50 | 50 | 25 |
| 4 | 3.5 | 35 | 1. | 10 | 12.6 | 3 | 67 | 11.1 | 50 | 50 | 25 |
| 5 | 6.7 | 67 | 1.5 | 15 | 9.5 | 2.25 | 50 | 11.1 | 50 | 50 | 25 |
| 6 | 6.7 | 67 | 1.5 | 15 | 12.6 | 3 | 67 | 11.1 | 50 | 50 | 25 |
| 7 | 6.7 | 67 | 0 | 0 | 9.5 | 2.25 | 50 | 11.1 | 50 | 50 | 25 |
| 8 | 6.7 | 67 | 0 | 0 | 12.6 | 3 | 67 | 11.1 | 50 | 50 | 25 |
| 8b | 6.7 | 67 | 0 | 0 | 12.6 | 3 | 67 | 11.1 | 50 | 50 | 25 |
| 9 | 6.7 | 67 | 1.5 | 15 | 9.5 | 2.25 | 50 | 11.1 | 50 | 50 | 25 |
| 10 | 3.5 | 35 | 0 | 0 | 12.6 | 3 | 67 | 11.1 | 50 | 50 | 25 |
| 10b | 3.5 | 35 | 0 | 0 | 12.6 | 3 | 67 | 11.1 | 50 | 50 | 25 |
| 11 | 0 | 67 | 0 | 0 | 12.6 | 3 | 67 | 11.1 | 50 | 50 | 25 |
| 11b | 0 | 67 | 0 | 0 | 12.6 | 3 | 67 | 11.1 | 50 | 50 | 25 |

### Example 10

### Preparation of Reaction Product of methylol melamine with pentaerythritol and polyphosphoric Acid with Ingredient Ratios Shown in Table XX

The preparation was identical to that example 9 but with sodium polyphosphate (polyphosphate of unknown average chain length). The pH of the samples in Table XX were above 5.

TABLE XX
The reaction product of methylol melamine with pentaerthritol and
polyphosphoric acid.

| Pop | pent | H2O | mel | pform | H2O | hexp | H2O | ixr | H2O | foam |
|---|---|---|---|---|---|---|---|---|---|---|
| 1 | 3.4 | 35 | 12.6 | 3 | 67 | 11.5 | 50 | 50 | 25 | very good |
| 3 | 6.7 | 67 | 12.6 | 3 | 67 | 10.8 | 50 | 50 | 25 | very good |

When heated in an oven at 500C., samples pmpp8, pmpp10 and sample pop3 showed a lot of foaming. As a further test of FR behavior, polyethylene bars 0.125 inch thick of samples pmpp8, pmpp10, and pop3 were prepared by mixing 60% polyethylene powder (PE) with 40% of these samples. The bars were pressed at about 220° C. with no mixing in the melt. Such films have a poor dispersion of the additive in the matrix compared to melting, mixing, and then pressing a bar. Yet, improved FR behavior was obvious from Table XXI. Comparison was made to similarly prepared films containing 40% MPP and another film containing 30% MPP and 10% dipentaerythritol, the combination that worked in polypropylene. Table XXI compares the number of times a 1.5″×1.5″ sample passed a 10 second burn from the bottom using a small methane torch, with a small flame. The second flame was applied for another 10 seconds immediately after the first flaming goes out as in a UL94 test. The test thus consisted of two consecutive 10 second bums on one sample. The test was repeated four times. The FR utility of the compounds of Table XIX and Table XX compared to MPP and dipentaerythritol was clear. Polyethylene has been one of the most difficult polymers to flame retard, because it forms very little char.

TABLE XXI
The number of passes out of 4 trials of FR additives in polyethylene
(PE) at 40% loading.

| FR compound | polyhydric | PE | 1^{st} burn | 2^{nd} burn |
|---|---|---|---|---|
| 40% MPP | 0% | 60% | 4/4 | 0/4 |
| 30% MPP | 10% | 60% | 0/4 | 0/4 |
| | dipentaerythritol | | | |
| 40% pmpp8 | 0% | 60% | 4/4 | 4/4 |
| 40% pmpp10 | 0% | 60% | 4/4 | 3/4 |
| 40% pop3 | 0% | 60% | 4/4 | 4/4 |

### Example 11

### Pop3/DMAc

Preparation of 20% mixture of sub-micron particles of methylol melamine compound of pentaerythritol and polyphosphoric acid (Table XX, sample pop3) in dimethyl acetamide (DMAc).

Ten g of pop3 from Table XX was added to 40 g DMAc. A media mill by Netzsch Inc, Exton, Pa. was found to work exceedingly well for wet grinding this mixture to a submicron size. This material was used in next three examples.

### Example 12

### Preparation of MPD-I with pop3

Dissolve anhydrous CaCl₂ into DMAc to make a 9% solution. Dissolve 5 g MPD-I polymer poly(m-phenylene isophthalamide) in 45 g CaCl₂/DMAc by raising temperature to about 80° C. and under nitrogen. About 50 g yellowish viscous polymer spin solution results after substantial time. Mix pop3/DMAc from example 11 with 50 g of the spin solution so that the loading is 10%. Prepare film by using a 5 mil doctor blade to spread the spin solution evenly on a glass plate. Place the glass plate with the 5 mil thick polymer film on a hot plate at about 90° C. for about 2 hours. Then place the hot glass plate in a vacuum oven at about 130° C. to remove the rest of the DMAc. After cooling, remove film by placing in water bath. Place on pin frame and dry in vacuum oven. Simultaneously, prepare a control film of MPD-I.

The first observation is that both MPD-I films (with and without pop3) is very flexible indicating that the pop3 addition does not destroy the film properties. The film with POP3 is white and darkens very slightly when placed in the sun for 8 hours as compared to the control which darkens substantially. This observation suggests that the UV stability is not made worse but possibly better by addition of POP3. The control film burns readily when a flame is held to the bottom of the film. The film containing POP3 is very difficult to ignite and the flame goes out very quickly when the flame is removed as compared to the control MPD-I film. This data indicates that fibers and films of MPD-I containing the compounds of this invention material have enhanced flame retardance.

### Example 13

### Preparation of Spandex Containing POP3

Preparation of spandex fibers is reviewed in Encyclopedia of Chemical Technology, V18, fourth edition, pp 614-632. The generic name spandex designates a fiber comprised of at least 85% of a segmented polyurethane. In practice, spandex consists of urethane hard segments connected by polyether or polyester soft segments. Hard segments are high melting and soft segments are low melting and provide extension. One traditional form of spandex is based on polytetramethylene glycol (PTMG), methylenebis (4-phenylisocyanate) (MDI), and toluene di-isocyanate (TDI).

PTMG (92%)+2,4 TDI (8%)>(PTMG dimer (100%) at 80 C. and 2-3 hours

Dimer (100%)+MDI(25%)>(prepolymer (125%) at 80 C. for 1 hour

Prepolymer (125%)+DMF (75%)+H₂NNH₂.H₂O+DMF (425)>(20% polymer solution in 2-3 min)

At this stage add POP3/dmac from example 11 is added to 40 g of spandex polymer so that the loading of pop3 is about 10%. Prepare films by using a 5 mil doctor blade to spread the film on a glass plate. Put glass plate on hot plate set at 90 C. for about 1 hour and then place in a vac oven at 110 C. until all solvent is removed. After cooling, remove film from glass plate. Simultaneously, prepare control film and process according. Upon igniting film from the bottom, control film burns very rapidly. Spandex film with 10% loading of POP3 burns slowly and is much improved in flame resistance. Spandex fibers of such material will also show improved FR behavior.

### Example 14

### Polyimide Doped with POP3

Preparation of polyimide follows the preparation procedure of Kazuhisa Yano et al., J. Pol Sci., 31 (10), 2493-98 (1993). In a 500 ml three necked flask, put 5.24 g of 4,4′-diaminodiphenylether and 51.6 g of DMAc. Stir this mixture for 30 minutes at 30 C. Add 5.70 g of pyromellitic dianhydride and stir at 30 C. for 1 hr. The result is a 16 wt % DMAc solution of polyamic acid. Next stir vigorously at 30 C. for 5 hours, 3.8 g of DMAc, and 6.13 g of polyamic solution. The conditions must be such that the polymer solution has good viscosity for preparation of films. The last step is addition of POP3/DMAc to the polymeric solution to obtain 10% loading and heating to 70 C. Spread solution on glass plate with 4 mil doctor knife. Place in draft for 2 days to remove DMAc. Heat at 100 C. for 1 hour and at 300 C. for 2 hours under nitrogen pressure. A thin film of polyimide doped with POP3 results. Such a film will have improved FR behavior because of the presence of the phosphorous.

### Example 15

### The Reaction Product of methylol melamine with phosphoric Acid

Methylol melamine was prepared by adding 1181 g melamine and 281 g parafornaldehyde to 6400 g of water and heating to boiling until clear solution formed. In a separate vessel, 489 g of 85% concentrated phosphoric acid was added to 3300 g of water and heated to a temperature of about 75° C. The boiling methylol melamine solution was slowly added to the acid solution over about 5 minute with vigorous stirring. The product was stirred for additional 30 minutes then allowed to cool over 6 hours, filtered, then dried. When placed in an oven at about 500° for 2 minutes good foam formed indicating good intumescense.

### Example 16

### The Reaction Product of methylol melamine with phosphoric Acid and pentaerythritol

Methylol melamine and phosphoric acid were prepared as in example 15. In a separate vessel, 105 g pentaerythritol was dissolved in 1000 g boiling water which was then added to the acid solution. The remaining steps were as in example 15. The product exhibited about twice the foam formation in an oven indicating more intumescense than that of example 15.

### Example 17

### Heat Treatment of Reaction Product

Heat the composition from example 15 in an oven at 300° C. for about 5 to 10 minutes so that all particles are heated somewhat uniformly, which requires mixing of the particles or thinly spread.

### Example 18

### The Reaction Product of methylol melamine with polyphosphoric Acid

Methylol melamine was prepared by adding 1181 g melamine and 281 g paraformaldehyde to 6400 g of water and heating to boiling until clear solution formed. In a separate vessel, 956 g of sodium polyphosphate (hexp) was dissolved in 4700 g of water. The solution was run through a 4″ ion exchange column containing about 6 liters of ion exchange resin with the resultant polyphosphoric acid solution collected. The boiling methylol melamine solution was slowly added to the acid solution over about 5 minutes with vigorous stirring while heating. The product was stirred and heated for additional 30 minutes then allowed to cool over 6 hours, filtered, then dried. When placed in an oven at about 500° for 2 minutes good foam formed indicating good intumescense.

### Example 19

### The Reaction Product of methylol melamine with polyphosphoric Acid and pentaerythritol

The same procedure was followed as in example 18 except that 220 g of pentaerythritol was dissolved in 2000 g boiling water, which was then added to the polyphosphoric acid solution. The boiling methylol melamine solution was added to the acid/pentaerythritol solution as in example 18. The observed intumescense or foaming exceeded that of example 18.

We claim:

1. A composition comprising the reaction product of either (a) or (b) with (c):
(a) one to four moles of an amine wherein at least one sixteenth of the amine molecules have at least one methylol bond and the maximum being fully methylolated amine molecules;
(b) one to four moles of a phenol wherein at least one sixteenth of the phenol molecules have at least one methylol bond and the maximum being fully methylolated phenol molecules; and
(c) one mole of a compound selected from the group consisting of mineral acids, acid chlorides, organic acids, organo-phosphorous acids, and a mixture of the acids, and optionally comprising zero to one mole of polyhydric material and optionally comprising zero to one mole of formaldehyde.

2. The composition of claim 1 wherein the composition has been heated at a temperature greater than about 90° C. but less than about 340° C. for less than 60 minutes

3. The composition of claim 1 wherein the composition is coated with 0.1% to 6% by weight of ethylene diamine relative to weight of composition.

4. The composition of claim 1 wherein (a) is reacted with (c) and the amine is selected from the group consisting of urea, melamine, ethylene diamine, benzoguanamine, acetoguanamine, dihydroxyethyleneurea, glycouril, and a mixture of one or more thereof, and (c) is selected from the group consisting of phosphoric acid, pyrophosphoric acid, polyphosphoric acid, p-toluene sulfonic acid, and mixtures thereof, and optionally comprising 0.0 to 1.0 mole of polyhydric material per mole of acid.

5. The composition of claim 1 wherein (a) is reacted with (c) and the amine is selected from the group consisting of urea, melamine, ethylene diamine, benzoguanamine, acetoguanamine, dihydroxyethyleneurea, glycouril, and a mixture of one or more thereof, and (c) is selected from the group consisting of phosphoric acid, pyiophosphoric acid, polyphosphoric acid, p-toluene sulfonic acid, and mixtures thereof, and comprising 0.1 to 1.0 mole of pentaerythritol per mole of acid.

6. The composition of claim 1 wherein (a) is reacted with (c) and the amine is selected from the group consisting of urea, melamine, and a mixture of one or more thereof, and (c) is selected from the group consisting of phosphoric acid, pyrophosphoric acid, polyphosphoric acid, p-toluene sulfonic acid, and a mixture of one or more thereof, and optionally comprising 0.0 to 1.0 mole of pentaerythritol per mole of acid.

7. The composition of claim 1 wherein (a) is reacted with (c) and the amine is melamine and (c) is selected from the group consisting of phosphoric acid, pyrophosphoric acid, polyphosphoric acid, p-toluene sulfonic acid, and a mixture of one or more thereof, and optionally comprising 0.0 to 1.0 mole of pentaerythritol per mole of acid.

8. The composition of claim 1 wherein (a) is reacted with (c) and the amine is selected from the group consisting of melamine, benzoguanamine, acetoguanamine, and a mixture of one or more thereof, and (c) is cyanuric acid.

9. The composition of claim 1 wherein the composition is a particulate having average particle size less than 3 microns.

10. The composition of claim 1 wherein the composition is coated with about 0.1% to 1% weight relative to weight of composition of a compound selected from the group consisting of organo functional silanes, ethylene diamine, ammonium hydroxide, sodium hydroxide, or calcium hydroxide.

11. The composition of claim 6 wherein the coating is an organo functional silane selected from the group consisting of gamma-aminopropyltrimethoxysilane, octyltriethoxysilane, gamma-glycidoxypropyltrimethoxysilane, gamma-methacryloxypropyltrimethoxysilane, and vinyltriethoxysilane

12. The composition of claim 1 wherein (b) is reacted with (c) and (b) is selected from the group consisting of phenol, cresol, xylenol, p-tert-butyl-phenol, p-phenylphenol, resorcinol, biphenol, catechol, hydroquinone, bisphenol-A, and mixtures thereof.

13. The composition of claim 4 wherein (a) is reacted with (c) and about 5% to 60% of the methylol bonds are alkylated.

14. The composition of claim 1 wherein (a) is reacted with (c) and the amine is selected from the group consisting of melamine, benzoguanamine, acetoguanamine and a mixture of one or more thereof, and (c) is selected from the group consisting of pentaerythritol phosphite, pentaerythritol phosphate (2,6,7,trioxa-1-phosphabicyclo(2,2,2) octane-4-methanol-1-oxide), pentaerythritol diphosphate, dipentaerythritol triphosphate, trimethylolpropane phosphite, trimethylolpropane phosphate, pentaerythritol thiophosphate, and methylol poly (hydrocarbylene aryl phosphate).

15. The composition of claim 1 wherein (c) is phosphorous oxy-chloride.

16. A process for preparing the composition of claim 1 which comprises the slow addition of a solution or mixture of (a) or (b), which is at a temperature less than or equal its boiling point, to a solution or mixture of (c), which is at a temperature less than or equal its boiling point, with the solvent for these solutions being water, an organic solvent, or a mixture of one or more thereof and with the further steps of heating the solutions to a temperature less than or equal the boiling point during and after mixing, drying the resultant reaction product, and then heating at a temperature greater than about 90° C. but less than about 340° C. for less than 60 minutes

17. The process of claim 16 wherein (a) is added to (c) and the amine is selected from the group consisting of urea, melamine, and a mixture of one or more thereof, and (c) is selected from the group consisting of phosphoric acid, pyrophosphoric acid, polyphosphoric acid, p-toluene sulfonic acid, and a mixture of one or more thereof, and optionally comprising 0.0 to 1.0 mole of pentaerythritol per mole of acid and the solvent is water, alcohol, or a mixture thereof.

18. The process of claim 16 wherein (a) is added to (c) and (a) is selected from the group consisting of urea, melamine, and a mixture of one or more thereof, and (c) is selected from the group consisting of phosphoric acid, pyrophosphoric acid, polyphosphoric acid, p-toluene sulfonic acid, and a mixture of one or more thereof, and optionally comprising 0.0 to 1.0 mole of pentaerythritol per mole of acid and the solvent is water.

19. A composition comprising
(d) 1 to 60 per cent by weight of the compound of claim 1 and
(e) 99 to 40 per cent by weight of a polymeric material that is either a thermoplastic with a melting point or substantial softening point greater than 80° C., a thermoset, or a latex coating composition.

20. The composition in claim 19 wherein (e) is a polymer selected from the group consisting of polyesters, synthetic aliphatic or aromatic polyamides, polyolefins, polycarbonates, polyvinyl chloride, polyvinyl acetate, and ethylene vinyl acetate.

21. The composition in claim 20 wherein (e) is selected from the group consisting of polyethylene terephthalate, polybutylene terephthalate, nylon 6, nylon 66, polyethylene, polypropylene, acrylonitrile-butadiene-styrene, and polystyrene.

22. The composition of claim 19 with about 1 to 40 per cent by weight of a reinforcing agent, relative to weight of composition before addition, selected from the group consisting of glass, carbon, mica, aramid fibers, and mixtures thereof.

23. The composition of claim 20 wherein (d) is 1% to 60% by weight of a compound from claim 6.

24. The composition of claim 19 wherein (d) is 1% to 60% by weight of a compound from claim 12 and e) is selected from the group in claim 20.

25. The composition of claim 19 wherein (e) is a thermoset selected from the group consisting of unsaturated polyester resins, saturated polyester resins, alkyd resins, amino resins, phenol resins, epoxy resins, diallyl phthalate resins, and polyacrylates and polyethers comprising one or more of these polymers and a crosslinking agent.

26. A process for pelletizing the powders of claim 1 consisting of the steps of:
(1) preparing a solution of methylol amine chosen from (a) in claim 1 or methylol phenol chosen from (b) claim 1 at a concentration of about 0.1% to 20% by weight of solution in a solvent chosen from the group consisting of water, organic solvent, or mixtures thereof;
(2) applying said solution to powders such that at least one half of the particles are wetted;
(3) allowing such particles to touch each other via application of pressure less than about 4 atmospheres; and
(4) drying particles to remove solvent.

27. The composition of claim 26 wherein the composition is that of claim 6.

28. The composition of claim 27 wherein the amine is chosen from the group consisting of methylol melamine, methylol urea, and mixtures thereof and the solvent is water.
